(19) United States
(12) Patent Application Publication
(10) Pub. No.: US 2026/0212219 A1
(43) Pub. Date: Jul. 23, 2026

(54) HYBRID CONTROLLER FOR RECORD MATCHING

(71) Applicant: Intuit Inc., Mountain view, CA (US)

(72) Inventors: Natalie BAR ELIYAHU, Petah Tikva (IL); Shon MENDELSON, Tel Aviv (IL); Hadas BAUMER, Petah Tikva (IL); Jackob LEMBERG, Givat Shmuel (IL); Lior TABORI, Tel Aviv (IL); Shahar KEREN, Haifa (IL); Sigalit BECHLER, Petah Tikva (IL); Ido Meir MINTZ, Tel Aviv (IL)

(73) Assignee: Intuit Inc., Mountain View, CA (US)

(21) Appl. No.: 19/029,127

(22) Filed: Jan. 17, 2025

(51) Int. Cl. G06N 5/025

(52) U.S. Cl. CPC G06N 5/025

(57) ABSTRACT

A method includes obtaining, by a server computing system, multiple source records from one or more source computing systems, processing, by a propensity model corresponding to each of multiple matching engines, the source records to obtain multiple sets of predicted execution statistics for the matching engines, and executing, by the server computing system, an optimization function using sets of predicted execution statistics to select a matching engine for each of the source records to obtain a selected matching engine for a corresponding source record. The method further includes processing, by the selected matching engine, the corresponding source record with multiple target records to identify a matching target record for each source record and relating the matching target record to the corresponding source record in a record repository.

### BACKGROUND

Data management is the process of extracting information from large volumes of data. A subset of data management is matching records. In record matching, the records from a source record repository are matched to records in a target record repository. A nominal case in record matching is where an exact match exists. For example, a rule based approach can match records that are the same or substantively the same with respect to the timestamps, numerical values, etc. In such nominal transaction cases, software performing transaction matching can use a rule based approach to the matching. A rule based approach applies a set of one or more rules that define whether one record matches another record. Rule based approaches are rigid. If a rule does not exist, then the records that record the same event are not matched.

However, in more complicated cases, the event may span days, weeks, or even months. Further, the records may not match exactly based on how the event is recorded. In the example, a rule based approach may not accommodate all of the different variations of transaction records to perform the matching.

Other techniques, such as Large Language Models (LLMs) may be used for record matching to accommodate the more complex matching. However, LLMs often suffer from hallucinations that cause incorrect matches to be found. Further, LLMs may require significant computing resources. Thus, a problem remains as to how a computer system can control computing system resource usage with accuracy of record matching.

### SUMMARY

In general, in one aspect, one or more embodiments relate to a method that includes obtaining, by a server computing system, multiple source records from one or more source computing systems, processing, by a propensity model corresponding to each of multiple matching engines, the source records to obtain multiple sets of predicted execution statistics for the matching engines, and executing, by the server computing system, an optimization function using sets of predicted execution statistics to select a matching engine for each of the source records to obtain a selected matching engine for a corresponding source record. The method further includes processing, by the selected matching engine, the corresponding source record with multiple target records to identify a matching target record for each source record and relating the matching target record to the corresponding source record in a record repository.

In general, in one aspect, one or more embodiments relate to a system that includes a computer processor, a matching application executing on the computer processor and that includes multiple matching engines, a propensity model corresponding to each of the matching engines configured to process multiple source records from one or more source computing systems to obtain multiple sets of predicted execution statistics for the matching engines, and an engine selector. The engine selector is configured to execute an optimization function using sets of predicted execution statistics to select a matching engine for each of the source records to obtain selected matching engine for a corresponding source record. The selected matching engine processes the corresponding source record with multiple target records to identify a matching target record for each corresponding source record. The system further includes a record repository configured to relate the matching target record to the corresponding source record.

In general, in one aspect, one or more embodiments relate to a method that includes obtaining a first set of training pairs of source records and target records, training multiple matching engines with first set of training pairs, obtaining a second set of training pairs of source records and target records, testing the matching engines with second set of training pairs to obtain a first plurality of sets of actual execution statistics, and training multiple propensity models with a second set of training pairs and the first plurality of sets actual execution statistics. The method further includes obtaining a third set of training pairs of source records and target records, processing the third set of training pairs with the propensity models to obtain multiple sets of predicted execution statistics, processing, by the matching engines, with the third set of training pairs to obtain a second plurality of sets of actual execution statistics, defining at least one parameter of an optimization function using the sets of predicted execution statistics and the second plurality of sets of actual execution statistics, and storing the optimization function, the matching engines, and the propensity models on a computing system.

Other aspects of one or more embodiments will be apparent from the following description and the appended claims.

### BRIEF DESCRIPTION OF DRAWINGS

FIG. 1 shows a system in accordance with one or more embodiments.

FIG. 2 shows a flowchart for record matching in accordance with one or

more embodiments.

FIG. 3 shows a flowchart for training the matching application in accordance with one or more embodiments.

FIG. 4A and FIG. 4B shows a system in accordance with one or more embodiments.

Like elements in the various figures are denoted by like reference numerals for consistency.

### DETAILED DESCRIPTION

One or more embodiments are directed to record matching. Matching records can be a challenge, where the level of complexity varies depending on the size and nature of the recording entities. For basic, straightforward matches, a simple heuristic might suffice in performing the matching process. However, for larger numbers of records and for more complex records, multiple comparison parameters are available, and similarity between the record attributes may exist. Thus, a more sophisticated matching model is required to handle such complexities. Due to the high volume, accuracy is important and should be balanced against budget and latency constraints. Striking the balance between resource usage and minimizing costs while achieving high accuracy poses a significant challenge in this complex environment.

One or more embodiments are directed to balancing computer system resource usage with accuracy. One or more embodiments are directed to a hybrid controller. The hybrid controller includes an engine selector connected to separate matching engines. A matching engine implements a particular process for matching records. Each matching engine is connected to a propensity model. The propensity model generates predicted execution statistics for the corresponding matching engine to match particular source records. For example, the predicted execution statistics may include a predicted accuracy level, a predicted latency, and a predicted resource usage of a corresponding source record. Based on the predicted execution statistics, the engine selector selects a corresponding engine. Notably, the matching engine is not executed until after selected by the engine selector. Thus, the resource usage is saved for simple record matching and accuracy for complex record matching.

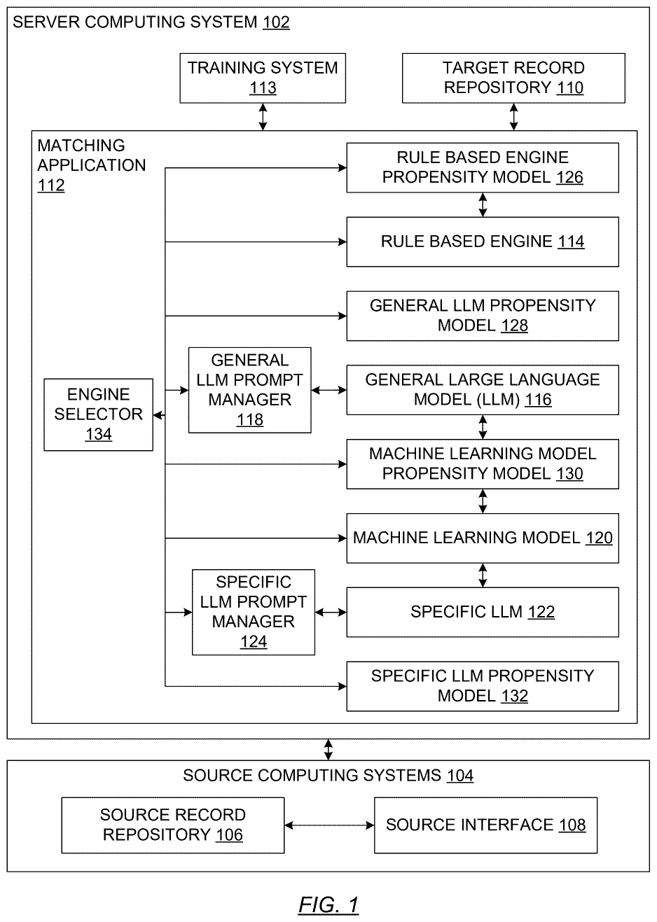

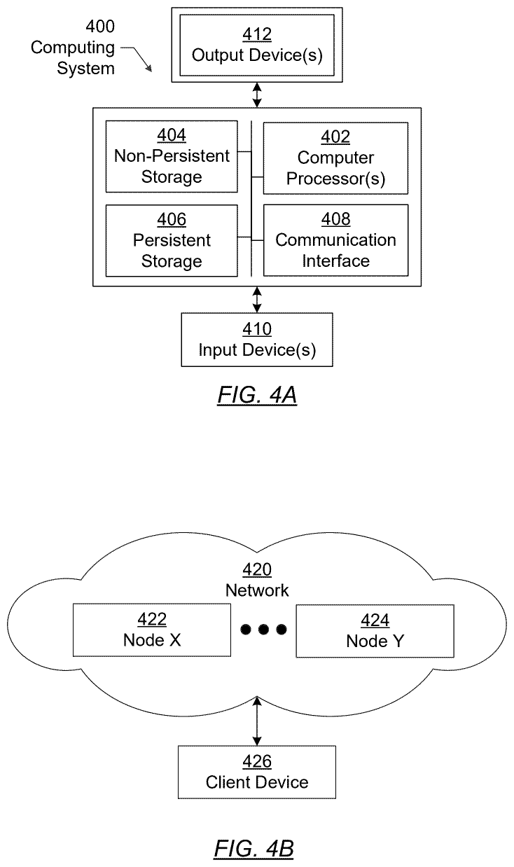

Attention is now turned to the figures. As shown in FIG. 1, a server computing system (102) accesses source computing systems (104). The server computing system (102) and source computing systems (104) may be the computing system discussed in FIG. 4A and FIG. 4B.

The source computing systems (104) are computing systems that are the source of records. For example, the source computing systems (104) may be third-party computing systems that separately records events as records. Each source computing systems (104) include a source record repository (106) and a source interface (108).

In general, a data repository (e.g., source record repository (106), target record repository (110)) is a type of storage unit or device (e.g., a file system, database, data structure, or any other storage mechanism) for storing data. The data repository may include multiple different, potentially heterogeneous, storage units and/or devices. The data repositories in the system include a source record repository (106) and a target record repository (110).

The source record repository (106) and target record repository (110) (described below) both store records. The source record repository (106) stores source records or records that are gathered for the purposes of the matching process. For example, the source records may be third-party records. The target record repository (110) stores target records. The target records may be records of the server computing system (102).

A record is a recording of an event and includes attributes of the event. The attributes may include a timestamp, a string description, one or more numerical values, etc. The same event may have one or more records on each of the source record repository (106) and the target record repository (110). Further, the number of records on the source record repository (106) and the target record repository (110) that record the same event may be different. For example, the source record repository (106) may have one record of the event and the target record repository may have two records of the event.

The source interface (108) is an interface in which the source computing systems (104) expose the source records. For example, the source interface (108) may be an application programming interface (API) or graphical user interface (GUI).

The server computing system (102) is configured to access the source computing systems (104) through the source interface (108). The server computing system includes the target record repository (110) connected to a matching application (112) and a training system (113). The training system (113) is configured to train or generate the various components of the matching application (112). Training the various components is described below and in reference to FIG. 4.

The matching application (112) is software that is configured to match source records with target records. The matching application (112) includes various matching engines (e.g., rule based engine (114), general large language model (LLM) (116) with general LLM prompt manager (118), machine learning model (120), and specific LLM (122) with specific LLM prompt manager (124)). Each of the matching engines are connected to a corresponding propensity model (e.g., rule based engine propensity model (126), general LLM propensity model (128), machine learning model propensity model (130), and specific LLM propensity model (132)). An engine selector (134) is connected to the various propensity models and matching engines. Each of the components are described below.

A matching engine is software that is configured to implement a particular matching algorithm that matches source records to target records. Each matching engine has a corresponding execution statistics (e.g., latency, resource usage, and accuracy) resulting from executing the matching algorithm. FIG. 1 shows examples of matching engines implementing particular matching algorithms. Each of the example matching engines are described below.

The rule based engine (114) applies a set of rules as the matching process. For example, the set of rules may be based on timestamp and numerical attribute matching. Further, the set of rules may include matching based on normalized or otherwise modified versions of string attributes.

A general large language model (LLM) (116) with general LLM prompt manager (118) applies a generally trained LLM to perform the matching process. The general LLM (116) is a type of artificial intelligence (AI) program that performs natural language processing to recognize and generate text, images, and other content. The general LLM (116) may have hundreds of thousands to trillions of parameters. Examples of general LLMs include versions of ChatGPT®, Llama®, Mistral-7B®, and proprietary LLMs, etc. The general LLM (116) is generally trained to perform a variety of natural language processing tasks.

The general LLM (116) is connected to a general LLM prompt manager (118). A general LLM prompt manager (118) is configured to generate a prompt to the general LLM (116) for requesting the matching. For example, the general LLM prompt manager (118) may gather all or a portion of the unmatched target records for a source record and add the unmatched records to a prompt template that includes an instruction and one-shot examples to perform the match.

The machine learning model (120) is a model that is configured to apply general machine learning techniques to perform a matching process. For example, the machine learning model (120) may be a twin tower model, an encoder or decoder model, or other type of machine learning model.

A specific LLM (122) is an LLM that is specifically trained to perform the matching process. The specific LLM (122) may be the general LLM that is further trained to match records. The specific LLM (122) is connected to a specific LLM prompt manager (124). The specific LLM prompt manager (124) is configured to generate a prompt for the specific LLM. For example, the specific LLM prompt manager (124) may be configured to apply a prompt template to a source record and one or more target records to generate the prompt. The specific LLM prompt manager (124) may further be configured to interface with the specific LLM (122) to send the response and receive the result.

Continuing with the matching application (112), the matching application (112) further includes a propensity model (e.g., rule based engine propensity model (126), general LLM propensity model (128), machine learning model propensity model (130), and specific LLM propensity model (132)) for each matching engine.

The propensity model is a statistical model, machine learning model, or rules based model that is configured to predict execution statistics for the corresponding matching engine. The propensity model, uses, as input, the source record and potentially information about the target records or the target record repository to perform the estimation. The output of the propensity model is one or more predicted execution statistics as a set of predicted execution statistics for the corresponding source record.

The engine selector (134) is software that is configured to select the matching engine based on the predicted execution statistics. For example, the engine selector (134) may be an optimization function and corresponding solver that takes as input the set of predicted execution statistics and generate, as output, the selected matching engine for the source record.

While FIG. 1 shows a configuration of components, other configurations may be used without departing from the scope of one or more embodiments. For example, various components may be combined to create a single component. As another example, the functionality performed by a single component may be performed by two or more components.

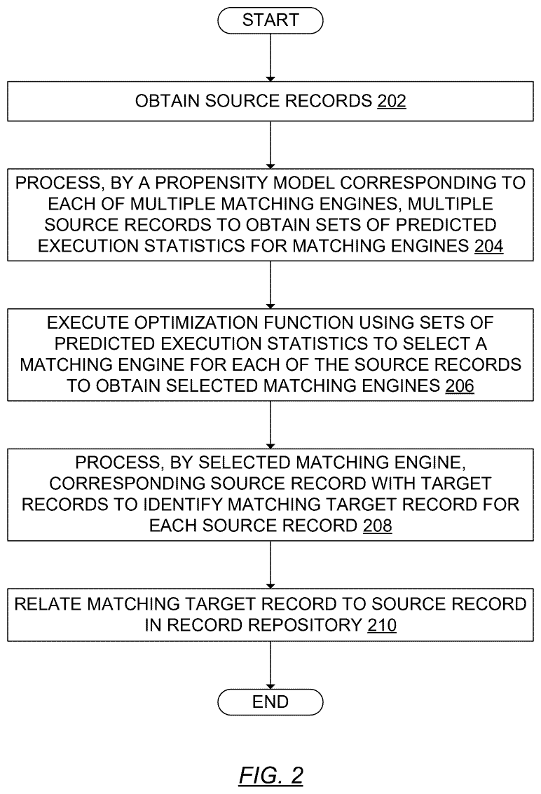

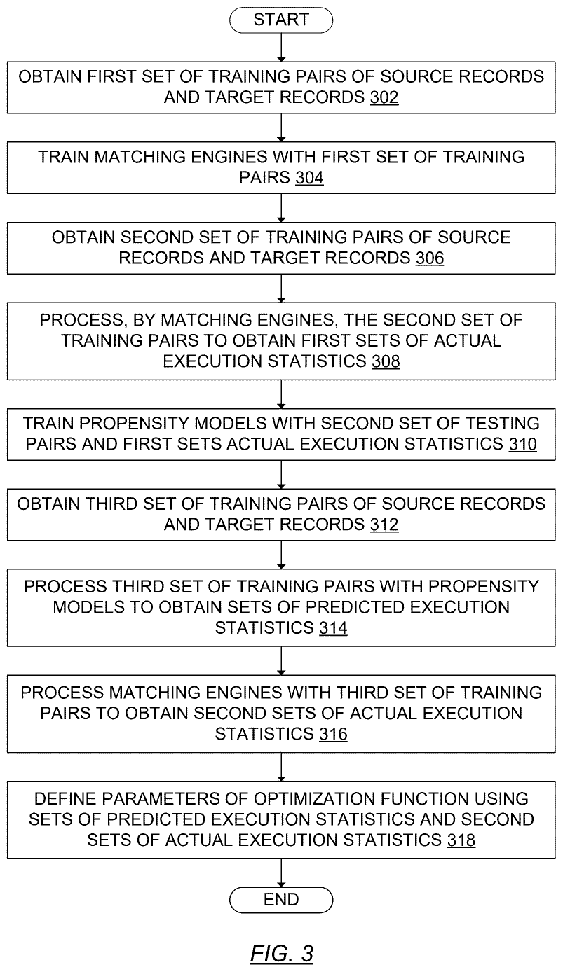

FIGS. 2 and 3 show flowcharts in accordance with one or more embodiments. The method of FIG. 2 may be implemented using the system of FIG. 1 and one or more of the steps may be performed on or received at one or more computer processors. While the various steps in these flowcharts are presented and described sequentially, at least some of the steps may be executed in different orders, may be combined or omitted, and at least some of the steps may be executed in parallel. Furthermore, the steps may be performed actively or passively.

FIG. 2 shows a flowchart for matching source records to target records in one or more embodiments. In Block 202, source records are obtained. For example, the source records may be obtained by performing screen scraping of one or more source interfaces or by sending a query to the one or more source computing systems using the API of the source computing systems.

In Block 204, the propensity models corresponding to each of multiple matching engines process multiple source records to obtain sets of predicted execution statistics for matching engines. In one or more embodiments, features of each source record are extracted to generate a set of source record features. The features may be the attributes of the source record or inferred features of the source record. The inferred features include properties about the attributes (e.g., whether string descriptions are recognizable, whether optional attributes are populated, etc.). Additional features, such as features of the target record repository, are also gathered and added to the set of source record features. Each propensity model independently processes each set of source record features to generate, for the corresponding matching engine, the set of execution statistics for the combination of the matching engine and the source record. Stated another way, a set of execution statistics exists for each combination of matching engine and source record.

In Block 206, optimization function is executed using sets of predicted execution statistics to select a matching engine for each of the source records to obtain selected matching engines. The optimization function includes a maximization function to maximize the predicted overall accuracy subject to a set of constraints. The set of constraints includes a limit on maximum latency, resource limit, and the confidence based on the probability. The set of constraints also includes various learnable parameters that are learned during a training phase described in FIG. 3. Linear or nonlinear programming solver, depending on the implementation of the optimization function, may execute on the optimization function to generate a matching engine for each source record. Namely, the optimization function may assign to each source record, a corresponding matching engine.

In Block 208, the selected matching engine processes the corresponding source record with target records to identify a matching target record for each source record. The matching engine processes the attributes of the source records with one or more of the target records to identify at least one matching target record for the source record.

In Block 210, the matching target records are related to a source record in the record repository. For each source record, the identifier of the source record is related to the identifier of the matching target record in storage. Thus, further processing may be performed according to the match. For example, the further processing may be to populate an interface with the match, generate a report, or perform another action.

FIG. 3 shows a flowchart for training the matching application in accordance with one or more embodiments. In Block 302, a first set of training pairs of source records and target records are obtained. The training pairs may be obtained from third-party sources. For example, training pairs may be obtained by validating existing matching approaches. As another example, training pairs may be from a human performing a matching process.

In Block 304, the matching engines are trained with the first set of training pairs. The various matching engines may be independently trained and may each be trained with the entire first set of training pairs. For example, a rules generator may be applied to the first set of training pairs to perform pattern matching and extract a set of rules that match the training source records to the training target records. The machine learning model may be trained by iteratively processing each training source record with the target records to generate a predicted match, comparing the predicted match with the set of pairs to generate a loss value, and back propagating the loss value. The general LLM matching engine may be trained by training the prompt manager. Specifically, prompt engineering may be performed on the prompt manager to identify a set of instructions and few-shot examples that increase the accuracy of the matches. The specific LLM matching engine may be trained similar to training the machine learning model and the general LLM prompt manager. For example, both prompt engineering and backpropagating losses may be used to train the specific LLM matching engine. When the matching engines are deemed trained, the flow may proceed to Block 306.

In Block 306, a second set of training pairs of source records and target records are obtained. Obtaining the second set of training pairs may be obtained in a same or similar manner to obtaining the first set of training pairs.

In Block 308, the matching engines process the second set of training pairs to obtain first sets of actual execution statistics. The processing in Block 308 is a testing process on the matching engines. Specifically, the matching engines are not updated further. Rather, execution statistics about the resource usage (e.g., amount of memory, execution times on the processor), latency, and accuracy of the match, is extracted for each training source record and for each matching engine.

In Block 310, the propensity models are trained with the second set of training pairs and the first sets actual execution statistics. The features of the source records are obtained as described in FIG. 2. For each training source record in the second step, the features are used as input to the respective propensity model to generate predicted execution statistics for the training source record. The predicted execution statistics are compared to the actual execution statistics of Block 308 and the parameters of the corresponding propensity model are updated. Through processing each source record, each propensity model is updated to improve the prediction accuracy of the execution statistics. Notably, in Block 310, the predicted accuracy of the matching engine is not updated.

In Block 312, a third set of training pairs of source records and target records are obtained. Obtaining the second set of training pairs may be obtained in a same or similar manner to obtaining the first set of training pairs.

In Block 314, the propensity models process the third set of training pairs to obtain sets of predicted execution statistics. The processing in Block 314 may be performed as described in Block 308.

In Block 316, the matching engines process the third set of training pairs to obtain second sets of actual execution statistics. The processing in Block 316 may be performed as described in Block 310. However, in Block 316, the parameters of the propensity models are not updated.

In Block 318, the parameters of the optimization function are defined using sets of predicted execution statistics and second sets of actual execution statistics. Specifically, the constants in the optimization function may be updated to compensate for different accuracy levels of the propensity models themselves and to set a priority between accuracy, latency, and resource usage.

Once trained, the trained various components of the matching application may be stored on the server computing system and used in a production environment. In the production environment, the processing of FIG. 2 is performed for thousands or millions of records. Because of the number of records, the computing system resources used are substantial. By selecting, on a per source record basis, a matching engine, the amount of resource usage is significantly reduced. This makes the computing system more efficient and capable of handling other processing tasks.

By way of example purposes only, the event may be a financial transaction. In the example, a financial transaction may be performed in a single time or over the course of days, weeks, or even months. For example, in a single point in time, the financial transaction may be performed at a point of sale device. As another example, at the time of an invoice, the consumer may immediately submit payment. In other examples, transactions may span a period of time, such as when services are performed over time or when goods are shipped or delivered. The records may correspondingly be at a single point in time or over a period of time. Further, the financial transaction records may not match exactly. By way of an example, one set of transaction records may be invoices from a vendor and other transaction records may be for payments to the vendor. A single payment may be for multiple invoices or may have added fees not listed on the invoice. Likewise, a single invoice may have multiple payments applied to the invoice. Thus, the transaction records may not match exactly.

In the example, multiple matching engines are used. For example, the rule based matching engine may apply a straightforward heuristic. The rule based matching engine may cross-check the amounts of payment and invoice, along with the payment and respective creation dates.

A second matching engine may be an optimization with a classic machine learning model. The second matching engine involves using optimization techniques to identify linkages between multiple invoices that can be matched with a single payment. The identified groupings are then fused together, and their characteristics recalculated (such as the combined amount of all the invoices in the grouping). To determine the most likely match (which could consist of a single invoice or multiple ones), the second matching engine may employ an appropriate classic ML designed for structured data (e.g., XGBoost).

A third matching engine may use a general LLM, without any fine-tuning. A prompt may be sent to the general LLM with “Your task is to find one or more matches for the following payment: Payment description−{Payment description}, Payment amount−{Payment amount}, Payment creation date {Payment creation date}. The invoice candidates are Inv 1: Invoice description {Inv_1 description}, Invoice amount−{Inv_1 amount}, Invoice creation date {Inv_1 creation date}; Inv 2: Invoice description {Inv_2 description}, Invoice amount−{Inv_2 amount}, Invoice creation date {Inv_2 creation date}; . . . ; Inv n: Invoice description {Inv_n description}, Invoice amount−{Inv_n amount}, Invoice creation date {Inv_n creation date} . . . . Please also provide a confidence score (range from zero to one) to your suggestion.” The prompt is then passed to an LLM (e.g., GPT-4) to search for possible matches.

A fourth matching engine may use a fine-tuned LLM to complete the matches found by the classic machine learning model. The fourth matching engine to combine both the classic machine learning model of the second approach and the LLM. The LLM is fine-tuned to complete the matches that were found by a classic ML algorithm. For example, consider the scenario where the correct invoice matches are [inv_1, inv_3, inv_7], while the classic machine learning model erroneously suggested [inv_1, inv_3, inv_8]. In order to address these scenarios, the LLM is fine-tuned to complete the matches, as a “Matching Completer LLM.”

To create a training dataset for the fine-tuned LLM, human annotators may generate positive and negative examples, with a positive completion for our hypothetical example being [inv_1, inv_3, inv_7], and a respective negative example being [inv_1, inv_3, inv_9] assuming inv_9 is a valid option. Using this training dataset, along with the above prompt with an additional statement such as “Please note that the classic ML model suggested matches for inv_1, inv_3, and inv_8.” The “Matching Completer LLM” may be fine-tuned using reinforcement learning.

Continuing with the example, for each matching engine that determines the likelihood of correctly predicting a payment's associated invoice candidate(s). This probability is based on information related to the payment and available invoice candidates. For example, if a payment for $100 has only one available invoice for $100 with a due date matching the payment date, a simple heuristic could likely make the correct match without the need for a complex or high-latency model. As a result, the propensity score for the rule based engine in this scenario would be very high.

Integer programming is used to optimize the propensity score while keeping the resource constraints in check. The limitations on the selection of the matching algorithm may include that the confidence score must meet the MIN_CONFIDENCE threshold for accuracy, the total budget for matching should not exceed BUDGET_LIMIT, and the overall latency should not exceed LATENCY LIMIT.

For each source record, embodiments choose which matching engine to use based on binary indicators y_{i,j}∈(0, 1) that determine whether matching engine j is used for source record i. Constants such as the source record's predicted execution statistics for each matching engine p_{i,j}, its cost c_{i,j}, and its latency l_{i,j} are also taken into account, since these can vary depending on individual samples and matching engines (e.g., generating larger prompts using the LLM can be more expensive). c_{i,j} and l_{i,j} are constants (user input) which estimate the cost and latency given a transaction.

The optimization function seeks to maximize the average matching confidence and minimize the resource usage, while still keeping the individual scores above the MIN_CONFIDENCE threshold. This ensures that the variance of the scores isn't too high, thereby helping to maintain the quality of matches. The following formulation may be used for the optimization function.

$$\begin{matrix} & MAX {\sum }_{i = 1}^{N} {\sum }_{j = 1}^{M} {y}_{i , j} * ( {p}_{i , j} - λ * {c}_{i , j} - δ * {l}_{i , j} ) \\ S . T . : & \\ & {y}_{i , j} ∈ ( 0 , 1 ) \\ & {\sum }_{j = 1}^{M} {y}_{i , j} < = 1 for each i ∈ ( 1 , N ) \\ & {\sum }_{j = 1}^{M} {y}_{i , j} * ( {p}_{i , j} - MIN\_CONFIDENCE ) >= 0 for each i ∈ ( 1 , N ) \\ & {\sum }_{i = 1}^{N} {\sum }_{j = 1}^{M} {y}_{i , j} * {c}_{i , j} < = BUDGET\_LIMIT \\ & {\sum }_{i = 1}^{N} {\sum }_{j = 1}^{M} {y}_{i , j} * {l}_{i , j} <= LATENCY\_LIMIT\end{matrix}$$

In the above formulation, the selection variables y_{i,j} are indicators. Each source record i is associated to at most one matching engine. If none of the matching engines suggest a match with a confidence score equal or greater than MIN_CONFIDENCE, a value of 0 to y_{i,j} is assigned for all matching engines j. The selected suggestion must meet the MIN_CONFIDENCE threshold.

A suitable matching engine is selected for each source record i, y_{i,j}=1 by prioritizing the highest matching confidence and accounting for the cost and latency involved. To quantify these factors with a common metric, the cost and latency may be multiplied by a constant (λ & δ). The constants serve at least two purposes: a) compensating for the difference in scale between matching confidence and cost/latency, and b) allowing the user to achieve the desired balance between accuracy and resource utilization by setting the appropriate values for λ & δ.

In the above example formulation, a linear programming solver may be used, such as GNU Linear Programming Kit (GLPK).

During inference, for each source record i, the selected matching engine j (y_{i,j}=1) is used to suggest a match for the user.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 4A, the computing system (400) may include one or more computer processor(s) (402), non-persistent storage device(s) (404), persistent storage device(s) (406), a communication interface (408) (e.g., Bluetooth interface, infrared interface, network interface, optical interface, etc.), and numerous other elements and functionalities that implement the features and elements of the disclosure. The computer processor(s) (402) may be an integrated circuit for processing instructions. The computer processor(s) (402) may be one or more cores, or micro-cores, of a processor. The computer processor(s) (402) includes one or more processors. The computer processor(s) (402) may include a central processing unit (CPU), a graphics processing unit (GPU), a tensor processing unit (TPU), combinations thereof, etc.

The input device(s) (410) may include a touchscreen, keyboard, mouse, microphone, touchpad, electronic pen, or any other type of input device. The input device(s) (410) may receive inputs from a user that are responsive to data and messages presented by the output device(s) (412). The inputs may include text input, audio input, video input, etc., which may be processed and transmitted by the computing system (400) in accordance with one or more embodiments. The communication interface (408) may include an integrated circuit for connecting the computing system (400) to a network (not shown) (e.g., a local area network (LAN), a wide area network (WAN) such as the Internet, mobile network, or any other type of network) or to another device, such as another computing device, and combinations thereof.

Further, the output device(s) (412) may include a display device, a printer, external storage, or any other output device. One or more of the output device(s) (412) may be the same or different from the input device(s) (410). The input device(s) (410) and output device(s) (412) may be locally or remotely connected to the computer processor(s) (402). Many different types of computing systems exist, and the aforementioned input device(s) (410) and output device(s) (412) may take other forms. The output device(s) (412) may display data and messages that are transmitted and received by the computing system (400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (402), is configured to perform one or more embodiments, which may include transmitting, receiving, presenting, and displaying data and messages described in the other figures of the disclosure.

The computing system (400) in FIG. 4A may be connected to, or be a part of, a network. For example, as shown in FIG. 4B, the network (420) may include multiple nodes (e.g., node X (422) and node Y (424), as well as extant intervening nodes between node X (422) and node Y (424)). Each node may correspond to a computing system, such as the computing system shown in FIG. 4A, or a group of nodes combined may correspond to the computing system shown in FIG. 4A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (400) may be located at a remote location and connected to the other elements over a network.

The nodes (e.g., node X (422) and node Y (424)) in the network (420) may be configured to provide services for a client device (426). The services may include receiving requests and transmitting responses to the client device (426). For example, the nodes may be part of a cloud computing system. The client device (426) may be a computing system, such as the computing system shown in FIG. 4A. Further, the client device (426) may include or perform all or a portion of one or more embodiments.

The computing system of FIG. 4A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining, by a server computing system, a plurality of source records from one or more source computing systems;
processing, by a propensity model corresponding to each of a plurality of matching engines, the plurality of source records to obtain a plurality of sets of predicted execution statistics for the plurality of matching engines;
executing, by the server computing system, an optimization function using the plurality of sets of predicted execution statistics to select a matching engine for each of the plurality of source records to obtain a selected matching engine for a corresponding source record;
processing, by the selected matching engine, the corresponding source record with a plurality of target records to identify a matching target record for each source record; and
relating the matching target record to the corresponding source record in a record repository.

2. The method of claim 1, wherein the plurality of matching engines comprise a rule based engine, general large language model (LLM) with general LLM prompt manager, machine learning model, and specific LLM with specific LLM prompt manager.

3. The method of claim 1, wherein processing by the propensity model comprises extracting a set of features for each source record of the plurality of source records and processing the set of features by the propensity model to obtain a set of predicted execution statistics for the source record, the set of predicted execution statistics in the set of execution statistics.

4. The method of claim 3, wherein the set of features comprises an attribute of the source record and an inferred feature of the source record.

5. The method of claim 1, further comprising:
obtaining a first set of training pairs of source records and target records;
training the plurality of matching engines with first set of training pairs;
obtaining a second set of training pairs of source records and target records;
testing the plurality of matching engines with second set of training pairs to obtain a first plurality of sets of actual execution statistics;
training a plurality of propensity models with a second set of training pairs and the first plurality of sets actual execution statistics, the plurality of propensity models comprising the propensity model;
obtaining a third set of training pairs of source records and target records;
processing the third set of training pairs with the plurality of propensity models to obtain a plurality of sets of predicted execution statistics;
processing, by the plurality of matching engines, with the third set of training pairs to obtain a second plurality of sets of actual execution statistics; and
defining at least one parameter of the optimization function using the plurality of sets of predicted execution statistics and the second plurality of sets of actual execution statistics.

6. The method of claim 5, further comprising:
executing a rule generator on the first set of training pairs to generate a set of rules for a rules based matching engine.

7. The method of claim 1, further comprising:
selecting, for a source record of the plurality of source records, a specific LLM matching engine, and wherein processing by the selected matching engine comprises:
executing a general machine learning model matching engine on the source record to obtain a set of candidate matches, and
sending the set of candidate matches to the specific LLM to select the matching target record for the source record.

8. A system comprising:
a computer processor:
a matching application executing on the computer processor and comprising:
a plurality of matching engines,
a propensity model corresponding to each of the plurality of matching engines configured to process a plurality of source records from one or more source computing systems to obtain a plurality of sets of predicted execution statistics for the plurality of matching engines, and
an engine selector configured to execute an optimization function using the plurality of sets of predicted execution statistics to select a matching engine for each of the plurality of source records to obtain selected matching engine for a corresponding source record,
wherein the selected matching engine processes the corresponding source record with a plurality of target records to identify a matching target record for each corresponding source record; and
a record repository configured to relate the matching target record to the corresponding source record.

9. The system of claim 8, wherein the plurality of matching engines comprise a rule based engine, general large language model (LLM) with general LLM prompt manager, machine learning model, and specific LLM with specific LLM prompt manager.

10. The system of claim 8, wherein processing by the propensity model comprises extracting a set of features for each source record of the plurality of source records and processing the set of features by the propensity model to obtain a set of predicted execution statistics for the source record, the set of predicted execution statistics in the set of execution statistics.

11. The system of claim 10, wherein the set of features comprises an attribute of the source record and an inferred feature of the source record.

12. The system of claim 8, further comprising a training system perform operations with the matching application comprising:
obtaining first set of training pairs of source records and target records;
training matching engines with first set of training pairs;
obtaining second set of training pairs of source records and target records;
testing matching engines with second set of training pairs to obtain first sets of actual execution statistics;
training propensity models with second set of testing pairs and first sets actual execution statistics;
obtaining third set of training pairs of source records and target records;
processing third set of training pairs with propensity models to obtain sets of predicted execution statistics;
processing matching engines with third set of training pairs to obtain second sets of actual execution statistics; and
defining parameters of optimization function using sets of predicted execution statistics and the second plurality of sets of actual execution statistics.

13. The system of claim 12, wherein the matching application is further configured to:
executing a rule generator on the first set of training pairs to generate a set of rules for a rules based matching engine.

14. The system of claim 8, wherein the matching application is further configured to:
selecting, for a source record of the plurality of source records, a specific LLM matching engine, and wherein the processing by the selected matching engine comprises:
executing a general machine learning model matching engine on the source record to obtain a set of candidate matches, and
sending the set of candidate matches to the specific LLM to select the matching target record for the source record.

15. A method comprising:
obtaining a first set of training pairs of source records and target records;
training a plurality of matching engines with first set of training pairs;
obtaining a second set of training pairs of source records and target records;
testing the plurality of matching engines with second set of training pairs to obtain a first plurality of sets of actual execution statistics;
training a plurality of propensity models with a second set of training pairs and the first plurality of sets actual execution statistics;
obtaining a third set of training pairs of source records and target records;
processing the third set of training pairs with the plurality of propensity models to obtain a plurality of sets of predicted execution statistics;
processing, by the plurality of matching engines, with the third set of training pairs to obtain a second plurality of sets of actual execution statistics;
defining at least one parameter of an optimization function using the plurality of sets of predicted execution statistics and the second plurality of sets of actual execution statistics; and
storing the optimization function, the plurality of matching engines, and the plurality of propensity models on a computing system.

16. The method of claim 15, further comprising:
executing a rule generator on the first set of training pairs to generate a set of rules for a rules based matching engine.

17. The method of claim 15, wherein the plurality of matching engines comprise a rule based engine, general large language model (LLM) with general LLM prompt manager, machine learning model, and specific LLM with specific LLM prompt manager.

18. The method of claim 15, wherein processing by a propensity model of the plurality of propensity models comprises extracting a set of features for each corresponding source record of a plurality of source records and processing the set of features by the propensity model to obtain a set of predicted execution statistics for the source record, the set of predicted execution statistics in set of execution statistics.

19. The method of claim 18, wherein the set of features comprises an attribute of the source record and an inferred feature of the source record.

20. The method of claim 15, further comprising:
processing a plurality of source records by the plurality of propensity models and the optimization function to select a matching engine of the plurality of matching engines for each corresponding source record of the plurality of source records;
selecting, by the matching engine corresponding to the corresponding source record, a matching target record of a plurality of target records; and
storing the matching target record with the corresponding source record.
